(19) United States
(12) Patent Application Publication
(10) Pub. No.: US 2024/0035104 A1
(43) Pub. Date: Feb. 1, 2024

(54) CONVERTER BLOWING CONTROL METHOD AND CONVERTER BLOWING CONTROL SYSTEM

(71) Applicant: JFE Steel Corporation, Tokyo (JP)

(72) Inventors: Tomohiro Sugino, Tokyo (JP); Yukio Takahashi, Tokyo (JP); Ryo Kawabata, Tokyo (JP); Shota Amano, Tokyo (JP); Naoki Kikuchi, Tokyo (JP); Hiroto Kase, Tokyo (JP); Toshiki Nonaka, Tokyo (JP)

(21) Appl. No.: 18/011,596

(22) PCT Filed: Apr. 30, 2021
(86) PCT No.: PCT/JP2021/017176

§ 371 Date: Dec. 20, 2022

(30) Foreign Application Priority Data
Jul. 1, 2020 (JP) 2020-113971

(51) Int. Cl. C21C 5/30; C21C 5/46; C21C 7/04; F27B 1/28; F27D 19/00; F27D 21/00

(52) U.S. Cl. CPC C21C 5/30; C21C 5/4673; C21C 7/04; F27B 1/28; F27D 19/00; F27D 21/0014; C21C 2300/06; F27D 2019/0003

(57) ABSTRACT

A converter blowing control method includes: calculating, by heat balance calculation and material balance calculation, an amount of oxygen supplied and an amount of a cooling material or a rising heat material charged to control a temperature and a component concentration of molten steel at end of blowing in a converter to target values; controlling the blowing in the converter based on the calculated amount of oxygen supplied and the calculated amount of a cooling material or a rising heat material charged; estimating a pre-blowing molten iron temperature that is a temperature of molten iron used as a raw material for blowing to be a target of the heat balance calculation, charged into the converter, and is in a state immediately before start of the blowing; and using the estimated pre-blowing molten iron temperature as a charged molten iron temperature in the heat balance calculation.

### TECHNICAL FIELD

This disclosure relates to a converter blowing control method and a converter blowing control system for controlling the temperature and component concentration of molten steel at the end of blowing to target values.

### BACKGROUND

The converter operation is a steelmaking process of obtaining molten steel by supplying oxygen to main raw materials including molten iron, scrap or the like charged into a converter to perform oxidation refining (blowing). In the converter operation, blowing control combining static control and dynamic control is performed to control the temperature and component concentration such as carbon concentration of molten steel at the end of blowing (blowing stop) to target values. In the static control, a mathematical model based on heat balance and material balance is used to determine, before the start of blowing, an amount of oxygen to be supplied and an amount of a cooling material or rising heat material to be charged necessary to control the temperature and component concentration of the molten steel to target values. On the other hand, in the dynamic control, the temperature and component concentration of molten metal are measured using a sublance during blowing, and the amount of oxygen to be supplied and the amount of a cooling material or rising heat material to be charged determined in the static control are corrected based on a mathematical model based on the heat balance and the material balance and a reaction model. Then, in the dynamic control, the amount of oxygen to be supplied and the amount of a cooling material or rising heat material to be charged before blowing stop are finally determined and controlled.

In the blowing control combining the static control and the dynamic control, if an error in the static control is too large, it is difficult to correct the error in the dynamic control, which sometimes makes it impossible to control the temperature and component concentration of the molten steel in blowing stop to the target values. Accordingly, it is necessary to minimize the error in the static control. The mathematical model used for the static control includes two types of calculations: heat balance calculation and oxygen balance calculation. In the heat balance calculation, the amount of a cooling material or rising heat material to be charged is calculated such that the sum of heat input into the converter and the sum of heat output from the converter are equal.

A formula used for the heat balance calculation includes a heat input determination term, a heat output determination term, a cooling term or a rising heat term, an error term, and a temperature correction term by an operator. To reduce the error in the static control, it is necessary to perform the heat balance calculation by giving an appropriate value to each term of the formula, and a method of determining an appropriate value has been studied. For example, JP 2012-87345 A discloses a method of predicting, based on a cooling curve obtained from a surface temperature of an inner clad refractory of a converter measured by a radiation thermometer and time information, an amount of temperature drop of molten steel in the subsequent blowing and incorporating the amount into heat balance calculation in static control.

However, even when the method disclosed in JP 2012-87345 A is applied, an error in the static control remains unresolved. Therefore, the control accuracy of the temperature of molten steel in blowing stop is not noticeably increased. In addition, a method has also been proposed in which information obtained sequentially during blowing, before measurement by a sublance, e.g., exhaust gas information during blowing (exhaust gas flow rate and exhaust gas component), is utilized and reflected in the converter operation so that estimation accuracy of the temperature and component concentration of the molten steel by a mathematical model is enhanced. For example, JP 2012-117090 A discloses a method of utilizing exhaust gas information to estimate a decarbonize-oxygen efficiency attenuation constant and a maximum decarbonize-oxygen efficiency that characterize decarburization characteristics during blowing, and using the estimation result to estimate the temperature and carbon concentration of the molten steel. According to the method disclosed in JP 2012-117090 A, since reaction heat generated in the decarburization reaction is accurately reflected in the estimation of the temperature of the molten steel, the control accuracy of the temperature of the molten steel in blowing stop is increased. However, since there are other factors affecting the temperature of the molten steel except for the decarburization reaction, the control accuracy of the temperature of the molten steel in blowing stop still did not reach a satisfactory level.

It could therefore be helpful to provide a converter blowing control method and a converter blowing control system capable of accurately controlling the temperature of molten steel at the end of blowing to a target value.

### SUMMARY

We thus provide:

A converter blowing control method includes: calculating, by heat balance calculation and material balance calculation, an amount of oxygen to be supplied and an amount of a cooling material or a rising heat material to be charged for controlling a temperature and a component concentration of molten steel at end of blowing in a converter to target values; and controlling the blowing in the converter based on the calculated amount of oxygen to be supplied and the calculated amount of a cooling material or a rising heat material to be charged, wherein the method includes: estimating a pre-blowing molten iron temperature that is a temperature of molten iron used as a raw material for blowing to be a target of the heat balance calculation, charged into the converter, and is in a state immediately before start of the blowing, and using the estimated pre-blowing molten iron temperature as a charged molten iron temperature in the heat balance calculation.

A converter blowing control method includes: sequentially estimating a temperature and a component concentration of molten metal at progress of blowing by sequentially performing heat balance calculation and material balance calculation during the blowing based on operation conditions and a measured value of a converter obtained at start of and during the blowing in the converter; and controlling the blowing in the converter based on the estimated temperature and the estimated component concentration of the molten metal, wherein the method includes: estimating a pre-blowing molten iron temperature that is a temperature of molten iron used as a raw material for blowing to be a target of the heat balance calculation, charged into the converter, and is in a state immediately before start of the blowing, and using the estimated pre-blowing molten iron temperature as a charged molten iron temperature in the heat balance calculation.

A value obtained by adding a post-charging molten iron temperature change amount to a molten iron temperature during charging may be used as the charged molten iron temperature used in the heat balance calculation, the post-charging molten iron temperature change amount being a molten iron temperature change amount in a period from when the molten iron is charged into the converter to when the blowing starts, and the molten iron temperature during charging being a temperature of the molten iron measured during a period when the molten iron used as the raw material for the blowing to be a target of the heat balance calculation is charged into the converter.

A value obtained by adding a pre-charging molten iron temperature change amount and a post-charging molten iron temperature change amount to a pre-charging molten iron temperature may be used as the charged molten iron temperature used in the heat balance calculation, the pre-charging molten iron temperature being a temperature of the molten iron measured during a period when the molten iron used as the raw material for the blowing to be a target of the heat balance calculation is held in a molten iron holding container before being charged into the converter, the pre-charging molten iron temperature change amount being a molten iron temperature change amount during a period from measurement of the pre-charging molten iron temperature to charging of the molten iron into the converter, and the post-charging molten iron temperature change amount being a molten iron temperature change amount during a period from when the molten iron is charged into the converter to when the blowing starts.

The post-charging molten iron temperature change amount may be determined based on a difference between a back-calculated value of the charged molten iron temperature back-calculated from the heat balance calculation to match a measured value of a molten metal temperature during blowing performed in past blowing and the molten iron temperature during charging in the past blowing.

The post-charging molten iron temperature change amount may be determined for further consideration of at least one of a time from when a previous charge of a target charge is discharged to when the molten iron of the target charge is charged and a time from when the molten iron of the target charge is charged to when the blowing starts.

The pre-charging molten iron temperature change amount may be determined based on a difference between the pre-charging molten iron temperature in the past blowing and the molten iron temperature during charging in the past blowing.

The pre-charging molten iron temperature change amount may be determined for further consideration of at least one of an elapsed time from a time at which the molten iron in the previous charge of the target charge is discharged to a receiving time at which the molten iron to be used for blowing of the target charge is received in a molten iron holding container for receiving the molten iron to be used for blowing of the target charge and a time from when the pre-charging molten iron temperature is measured to when the molten iron is charged into the converter.

The molten iron temperature during charging may be measured by using a non-contact optical method.

The non-contact optical method may be a method of measuring an emission spectrum emitted from the molten iron to calculate a temperature of the molten iron from a radiation energy ratio of two different wavelengths selected from the measured emission spectrum.

λ1 and λ2 may both be 400 nm to 1000 nm, and an absolute value of a difference between λ1 and λ2 may be 50 nm or more and 600 nm or less, where the two different wavelengths are λ1 and λ2 (>λ1).

λ1 and λ2 may both be 400 nm to 1000 nm, and an absolute value of a difference between λ1 and λ2 may be 200 nm or more and 600 nm or less, where the two different wavelengths are λ1 and λ2 (>λ1).

A measured value of the temperature of the molten iron may be corrected based on a predetermined ratio of emissivity of emission spectra of the two different wavelengths.

A converter blowing control system includes: a first computer configured to calculate, by heat balance calculation and material balance calculation, an amount of oxygen to be supplied to a converter and an amount of a cooling material or a rising heat material to be charged into the converter for controlling a temperature and a component concentration of molten steel at end of blowing in the converter to target values; a control device configured to control the blowing in the converter based on the amount of oxygen to be supplied to the converter and the amount of a cooling material or a rising heat material to be charged into the converter calculated by the first computer; a second computer configured to calculate a pre-blowing molten iron temperature that is a temperature of molten iron used as a raw material for the blowing in the converter, is charged into the converter, and is in a state immediately before start of the blowing; and at least one of a third computer configured to calculate, as a molten iron temperature during charging, a temperature of the molten iron used as the raw material for the blowing to be a target of the heat balance calculation by using two-color temperature information of the molten iron during a period when the molten iron is charged into the converter, a fourth computer configured to calculate a pre-charging molten iron temperature change amount that is a molten iron temperature change amount during a period from when a pre-charging molten iron temperature is measured to when the molten iron is charged into the converter, the pre-charging molten iron temperature being a temperature of the molten iron during a period when the molten iron used as the raw material for the blowing to be a target of the heat balance calculation is held in a molten iron holding container before being charged into the converter, and a fifth computer configured to calculate a post-charging molten iron temperature change amount that is a molten iron temperature change amount in a period from when the molten iron used as the raw material for the blowing to be a target of the heat balance calculation is charged into the converter to when the blowing starts, wherein the second computer is configured to calculate the pre-blowing molten iron temperature using at least one of the molten iron temperature during charging calculated by the third computer, the pre-charging molten iron temperature change amount calculated by the fourth computer, and the post-charging molten iron temperature change amount calculated by the fifth computer, and the first computer is configured to calculate, using the pre-blowing molten iron temperature calculated by the second computer as a charged molten iron temperature, the amount of oxygen to be supplied to the converter and the amount of a cooling material or a rising heat material to be charged into the converter for controlling the temperature and the component concentration of the molten steel at the end of the blowing in the converter to the target values by the heat balance calculation and the material balance calculation.

A converter blowing control system includes: a first computer configured to sequentially calculate a temperature and a component concentration of molten metal during blowing by performing heat balance calculation and material balance calculation based on operation conditions and a measured value of a converter obtained at start of and during the blowing in the converter; a control device configured to control the blowing in the converter based on the temperature and the component concentration of the molten metal during the blowing calculated by the first computer; a second computer configured to calculate a pre-blowing molten iron temperature that is a temperature of molten iron used as a raw material for the blowing in the converter, is charged into the converter, and is in a state immediately before start of the blowing; and at least one of a third computer configured to calculate, as a molten iron temperature during charging, the temperature of the molten iron used as the raw material for the blowing in the converter by using two-color temperature information of the molten iron during a period when the molten iron is charged into the converter, a fourth computer configured to calculate a pre-charging molten iron temperature change amount that is a molten iron temperature change amount during a period from when a pre-charging molten iron temperature is measured to when the molten iron is charged into the converter, the pre-charging molten iron temperature being a temperature of the molten iron used as the raw material for the blowing in the converter during a period when the molten iron is held in a molten iron holding container before being charged into the converter, and a fifth computer configured to calculate a post-charging molten iron temperature change amount that is a molten iron temperature change amount in a period from when the molten iron used as the raw material for the blowing in the converter is charged into the converter to when the blowing starts, wherein the second computer is configured to calculate the pre-blowing molten iron temperature using at least one of the molten iron temperature during charging calculated by the third computer, the pre-charging molten iron temperature change amount calculated by the fourth computer, and the post-charging molten iron temperature change amount calculated by the fifth computer, and the first computer is configured to sequentially calculate the temperature of the molten metal during blowing using, as a charged molten iron temperature, the pre-blowing molten iron temperature calculated by the second computer.

Therefore, according to our converter blowing control method and converter blowing control system, the temperature of molten steel at the end of blowing can be accurately controlled to a target value.

### BRIEF DESCRIPTION OF THE DRAWINGS

FIG. 1 is a schematic diagram illustrating a configuration of a converter blowing control system according to an example.

FIG. 2 is a diagram illustrating a relationship between an empty furnace time of a converter before blowing and a temperature difference obtained by subtracting an actual temperature obtained from a sublance charged in the middle of blowing from an estimated temperature for when a blowing start temperature is calculated as a molten iron temperature measured at the time of charging.

FIG. 3 is a diagram illustrating a relationship between a time from the end of molten iron charging to the start of blowing and a temperature difference obtained by subtracting an actual temperature obtained from a sublance charged in the middle of blowing from an estimated temperature for when a blowing start temperature is calculated as a molten iron temperature measured at the time of charging.

FIG. 4 is a diagram illustrating a temperature error of molten iron with respect to a target value at the end of blowing in an example of our method and a first comparative example.

### REFERENCE SIGNS LIST

1 CONVERTER BLOWING CONTROL SYSTEM

2 SPECTROSCOPIC CAMERA

3 FIRST COMPUTER

4 EXHAUST GAS FLOW METER

5 EXHAUST GAS ANALYZER

6 SECOND COMPUTER

7 CONTROL DEVICE

7a GAS FLOW RATE CONTROL DEVICE

7b SUBLANCE CONTROL DEVICE

7c AUXILIARY RAW MATERIAL CHARGING CONTROL DEVICE

8 THIRD COMPUTER

9 FOURTH COMPUTER

10 FIFTH COMPUTER

11 CONVERTER

12 MOLTEN IRON

13 CHARGING POT

### DETAILED DESCRIPTION

Hereinafter, an example of our converter blowing control method and converter blowing control system will be described.

### Converter Blowing Control Method

In the converter operation, blowing control combining static control and dynamic control is performed to control the temperature and component concentration such as carbon concentration of molten steel at the end of blowing (blowing stop) to target values. In the static control, a mathematical model based on heat balance calculation and material balance calculation is used to determine, before the start of blowing, an amount of oxygen to be supplied and an amount of a cooling material and rising heat material to be charged (hereinafter, referred to as a cooling material) necessary to control the temperature and component concentration of the molten steel to target values. Then, the blowing is started and progresses based on the determined amount of oxygen to be supplied and the determined amount of a cooling material to be charged, and the blowing is continued for a certain period of time (for example, a time point at which 80 to 90% of the amount of oxygen to be supplied calculated in the static control is blown), and then the temperature and component concentration of the molten metal are measured using a sublance. In the dynamic control, a mathematical model based on the temperature and component concentration of the molten metal measured using the sublance, the heat balance, the material balance, and the reaction model is used to correct the amount of oxygen to be supplied and the amount of a cooling material to be charged that are determined in the static control, and the amount of oxygen to be supplied and the amount of a cooling material to be charged before blowing stop are determined finally.

A calculation formula used for the heat balance calculation in the static control includes, for example, a heat input determination term, a heat output determination term, a cooling term or a temperature-rising term, an error term, and a temperature correction term by an operator. Among them, the heat input determination term includes a term representing sensible heat of the molten iron to be charged. (Even in the method disclosed in JP 2012-117090 A described above, the point that sensible heat of the molten iron to be charged needs to be given as an initial value is similar to the blowing control method combining the static control and the dynamic control.)

The sensible heat of the molten iron to be charged is calculated by a formula of (specific heat of molten iron)×(mass of molten iron to be charged)×(temperature of molten iron to be charged). As the specific heat of molten iron, a physical property value described in a handbook or the like is used. As the mass of molten iron to be charged, for example, a difference between the weight of a charging pot (molten iron holding container) filled with the molten iron measured by a load cell or the like before the molten iron is charged and the weight of an empty charging pot measured by a load cell or the like after the molten iron is charged is used. Further, as the temperature of molten iron to be charged (charged molten iron temperature), a value measured by immersing a thermocouple in molten iron filled in the charging pot is used, for example.

We found that a reason why the control accuracy of temperature of molten steel in blowing stop is not increased is that a value of the sensible heat of the molten iron to be charged is inaccurate in the heat balance calculation in the static control and the dynamic control. In particular, we found that, when the sensible heat of the molten iron to be charged is calculated, it is not always appropriate to use a measured value of the temperature of the molten iron described above.

Generally, the temperature of molten iron is measured after the molten iron is charged into a charging pot and residues are removed therefrom. However, after the temperature measurement, an elapsed time before the molten iron is charged into the converter greatly varies depending on the operation state of the converter and steelmaking process after the converter. For example, after the temperature of the molten iron is measured, the molten iron is immediately charged into the converter to start blowing in some instances, or after the temperature of the molten iron is measured, it may be forced to wait until the molten iron is charged into the converter in a state where the molten iron is filled in the charging pot as it is. That is, since an amount of temperature drop of the molten iron in a period from when the temperature of the molten iron is measured to when the molten iron is charged into the converter is different, the actual charged molten iron temperature is also different.

In particular, if the waiting time until the molten iron is charged into the converter is long, the temperature distribution of the molten iron occurs in the depth direction of the charging pot due to heat convection. In a charging pot with a loading weight of more than 200 tons, the depth of a molten iron bath when filled with molten iron is on the order of several meters, whereas the depth of immersion of the thermocouple at the time of temperature measurement is several tens of centimeters. For this reason, even if the temperature of the molten iron is measured again in the charging pot before the molten iron is charged into the converter, the influence of the temperature distribution of the molten iron is not sufficiently reflected in the temperature measurement value, which causes an error. The thermal history of the charging pot used also affects the amount of temperature drop of the molten iron in the period from when the temperature of the molten iron is measured to when the molten iron is charged into the converter. For example, in a charging pot in which the molten iron used for a charge to be a target of heat balance calculation is received, if an elapsed time (empty pot time) from a time at which the molten iron is discharged before receiving the molten iron to when the molten iron is received is short, then the amount of temperature drop of the molten iron during a period in which the molten iron is held in the charging pot is small. Conversely, if the empty pot time is long, then the amount of temperature drop of the molten iron during the period in which the molten iron is held in the charging pot is increased. Further, in addition to the state immediately before the molten iron used for a charge to be a target of heat balance calculation is received, a charging pot having a high ratio of the time (pot filled time) in the state of being filled with the molten iron within a certain period has a small amount of temperature drop of the molten iron, and conversely, a charging pot having a low ratio of the pot filled time has a large amount of temperature drop of the molten iron.

Further, the temperature of the molten iron has variations that affect the accuracy of the heat balance calculation other than during the molten iron is held in the charging pot. Specifically, there is a temperature variation in a period from when the molten iron is charged into the converter from the charging pot to when blowing is started. It usually takes about five minutes for the molten iron to be charged into the converter. However, we believe that the charging time varies depending on the state of the furnace throat of the converter into which the molten iron is to be charged (the state of adhesion of metal, etc.), and if the charging time is increased, then the temperature of the molten iron after the molten iron is charged into the converter drops by an amount corresponding to the increased time. In addition, the time from when the molten iron is completely charged into the converter to when blowing is started also varies depending on the operation status of a factory. For example, it may take ten minutes or more from when the molten iron is completely charged into the converter to when blowing is started. As described above, if the time from the end of molten iron charging to the start of blowing is increased, the temperature of the molten iron is considered to drop by an amount corresponding to the increased time. In addition, the temperature of the molten iron after charging also varies depending on the state of the converter into which the molten iron is charged. For example, we believe that a temperature drop of the molten iron after charging is small if a time (empty furnace time) from when a previous charge is discharged to when the next charge is charged is short. However, we believe that a temperature drop of the molten iron after charging is large if the empty furnace time is long.

As described above, we found that there is a situation where a value of the temperature of the molten iron used to calculate the sensible heat of the molten iron to be charged is not necessarily appropriate at. However, it is difficult to perform the operation while keeping constant the elapsed time before the molten iron is charged into the converter after the temperature measurement, the heat history of the charging pot and the converter and the like. In light of the above, we estimated, as the charged molten iron temperature used for heat balance calculation, a pre-blowing molten iron temperature, which is a temperature of the molten iron that is charged into the converter and is in a state immediately before the start of blowing, and used the estimated pre-blowing molten iron temperature. This increases the accuracy of heat balance calculation as compared with the related art and enables the temperature of the molten steel to be accurately controlled to a target value.

The estimated value of the pre-blowing molten iron temperature can be obtained as follows.
(a) When the temperature of the molten iron (molten iron temperature during charging) is measured while the molten iron used as a raw material in blowing to be a target of heat balance calculation is charged into the converter, and a measured value of the molten iron temperature during charging is obtained, an estimated value of the pre-blowing molten iron temperature is determined as a value obtained by adding a post-charging molten iron temperature change amount, which is a change amount of the temperature of the molten iron from when the molten iron is charged into the converter to when blowing starts, to the measured value of the molten iron temperature during charging, and the estimated value is used for the heat balance calculation. The post-charging molten iron temperature change amount takes a negative value when it is estimated that the temperature of the molten iron drops during a period from when the molten iron is charged into the converter to when blowing starts. Therefore, the estimated value of the pre-blowing molten iron temperature in this example is a value obtained by subtracting the absolute value of the post-charging molten iron temperature change amount from the measured value of the molten iron temperature during charging. The post-charging molten iron temperature change amount can be determined by the following calculation using data of the past blowing performed by measuring the molten iron temperature during charging.

First, as for the past blowing performed by measuring the molten iron temperature during charging, the charged molten iron temperature is back-calculated by heat balance calculation to match the actual value of the temperature of the molten metal during blowing actually measured with a sublance. A difference between the back-calculated charged molten iron temperature and the measured value of the molten iron temperature during charging of the same blowing in the past is considered to correspond to the post-charging molten iron temperature change amount. For example, it is assumed that, in a certain past blowing, the measured value of the molten iron temperature during charging is 1350° C. and the temperature of the molten metal measured with the sublance is 1550° C. Back calculation of heat balance calculation with only the charged molten iron temperature used as a variable is performed such that a solution of heat balance calculation for the past blowing is 1550° C. (all values other than the charged molten iron temperature are the same as the values used for heat balance calculation of the past blowing). Assuming that the back-calculated charged molten iron temperature is 1340° C., the post-charging molten iron temperature change amount is obtained as 1340-1350=−10° C.

In this way, as for each of the past blowing performed by measuring the molten iron temperature during charging, the post-charging molten iron temperature change amount is calculated, and the resultant is accumulated as data, whereby the post-charging molten iron temperature change amount can be determined based on the accumulated data in heat balance calculation for new blowing. In the heat balance calculation for new blowing, to determine the post-charging molten iron temperature change amount, an arithmetic average value of the accumulated post-charging molten iron temperature change amount itself may be taken and used, or, alternatively, the post-charging molten iron temperature change amount may be given as a function obtained by regression calculation or the like using, as variables, a time from when a previous charge of the corresponding past blowing is discharged to when the molten iron of the past charge is charged, a time from when the molten iron of the past charge is charged to when blowing of the past charge is started and the like.
(b) On the other hand, as for the molten iron used as a raw material in blowing to be a target of heat balance calculation, when the temperature of the molten iron which is charged into the converter is not measured, or when no measured value is obtained, the pre-blowing molten iron temperature is determined as a value obtained by adding a pre-charging molten iron temperature change amount, which is a change amount of the temperature of the molten iron during a period from the measurement of the pre-charging molten iron temperature to charging of the molten iron into the converter, and the post-charging molten iron temperature change amount to a pre-charging molten iron temperature, which is a temperature of the molten iron measured during a period when the molten iron is held in the molten iron holding container before being charged into the converter, and then the pre-blowing molten iron temperature is used for the heat balance calculation. The pre-charging molten iron temperature change amount takes a negative value when it is estimated that the temperature of the molten iron drops during a period from when the temperature is measured in the molten iron holding container to when the molten iron is charged into the converter. Therefore, the estimated value of the molten iron temperature during charging in this example is a value obtained by subtracting the absolute value of the pre-charging molten iron temperature change amount from the measured value in the molten iron holding container.

The pre-charging molten iron temperature change amount may be determined based on a difference between a temperature measurement value of the molten iron temperature in the charging pot and a temperature measurement value of the molten iron temperature during charging using data of the past blowing performed by measuring the molten iron temperature during charging. For example, in a certain past blowing, assuming that the temperature measurement value of the molten iron temperature in the charging pot is 1370° C. and the measured value of the molten iron temperature during charging is 1350° C., the pre-charging molten iron temperature change amount is obtained as 1350-1370=−20° C. As for the charging pot that received the molten iron used in the past blowing, an elapsed time (empty pot time) from a time at which the molten iron is discharged before the molten iron in the past is received to when the molten iron in the past is received may be recorded for each blowing, and the pre-charging molten iron temperature change amount may be given as a function obtained by regression calculation or the like using the empty pot time or the like as a variable. Incidentally, the post-charging molten iron temperature change amount may be determined in a manner similar to that in the above (a).

As the measurement of the molten iron temperature during charging, it is preferable to use a method of measuring the temperature of the molten iron by a non-contact optical method when the molten iron used as a raw material for blowing, which is a target of the heat balance calculation, flows into the converter from the charging pot. As the method of temperature measurement, a method of measuring by immersing a thermocouple or the like in an injection flow when the molten iron flows into the converter from the charging pot is possible. However, large-scale equipment is required to immerse the thermocouple in the injection flow. Accordingly, it is preferable to use a non-contact optical method with which the temperature can be measured more easily.

Examples of the non-contact optical method include a temperature measurement method using a two-color thermometer, a radiation thermometer, a thermoviewer or the like. In addition, when a temperature is measured by the non-contact optical method, it may be difficult to measure the temperature accurately because slag floats on the bath surface in the molten iron in a stationary state filled in the charging pot. On the other hand, when measurement is performed on an injection flow at the time of flowing into the converter from the charging pot, the surface of the molten iron is partly exposed so that more accurate measurement can be performed.

Among the non-contact optical methods described above, a method of measuring an emission spectrum emitted from the molten iron and calculating a temperature from a radiation energy ratio of two different wavelengths selected from the obtained emission spectrum, that is, a method using a two-color thermometer is more preferable. There is a possibility that the emissivity of the injection flow at the time of flowing into the converter from the charging pot, which is a target of the temperature measurement, varies depending on the measurement conditions. This is because, in the method using the two-color thermometer, even when the emissivity of the temperature measurement target varies, as long as a relationship between the two spectral emissivity having different wavelengths varies while maintaining a proportional relationship, the ratio of the two spectral emissivity depends only on the temperature so that accurate temperature measurement can be performed regardless of the variation in emissivity.

Assuming that the two different wavelengths are X1 and X2 (X1 <X2), it is preferable to select the wavelengths such that X1 and X2 satisfy the following relationship. Specifically, it is preferable that X1 and X2 are both 400 nm to 1000 nm and the absolute value of the difference between X1 and X2 is 50 nm or more and 600 nm or less. Even in the method using the two-color thermometer, a measurement error occurs when the emissivity of two emission spectra having different wavelengths do not vary while maintaining a proportional relationship with each other. For high-precision measurement, it is desirable to select a condition for reducing the variations in emissivity ratio R (R=ελ₁/ελ₂), which is the ratio of the emissivity ελ₁ and ελ₂ of two emission spectra having different wavelengths. We believe that the influence of stray light from an oxide film on the surface of the molten iron or the furnace wall, which is a factor of the variations in emissivity ratio R, is large on the long wavelength side where the emissivity is relatively small. Therefore, it is preferable to select the detection wavelength on the short wavelength side where the emissivity is large.

Specifically, it is preferable to select both λ1 and λ2 within 400 nm to 1000 nm. When the wavelength is less than 400 nm, it is difficult for an ordinary spectroscopic camera to detect radiation energy because the wavelength is short. On the other hand, when the wavelength exceeds 1000 nm, the wavelength is long, and thus the influence of variations in emissivity ratio increases. Further, the absolute value of the difference between λ1 and λ2 is preferably 50 nm or more and 600 nm or less. When the absolute value of the difference between λ1 and λ2 is less than 50 nm, the wavelengths of λ1 and λ2 are close to each other, and thus, it is difficult to perform spectroscopy with an ordinary spectroscopic camera. On the other hand, when the absolute value of the difference between λ1 and λ2 exceeds 600 nm, one wavelength is inevitably selected from the condition of long wavelength, and the influence of variations in emissivity ratio increases because of the long wavelength.

When the absolute value of the difference between λ1 and λ2 is 200 nm or more and 600 nm or less, the influence of variations in emissivity ratio R is reduced, which is more preferable. In addition, the emissivity ratio R may be determined in advance based on experiments or literature values, and the measured value of the temperature of the molten iron may be corrected with the emissivity ratio R determined in advance.

### Converter Blowing Control System

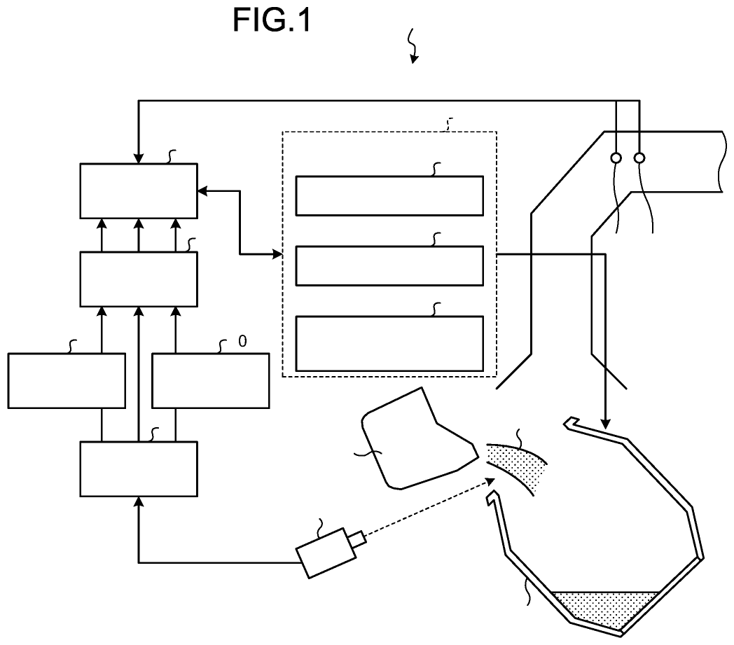

As illustrated in FIG. 1, a converter blowing control system 1 according to an example includes: a first computer 3 that calculates, by the heat balance calculation and the material balance calculation, an amount of oxygen to be supplied to a converter 11 and an amount of a cooling material to be charged into the converter 11 to control the temperature and component concentration of molten steel at the end of blowing in the converter 11 to target values; and a control device 7 that controls blowing in the converter 11 based on the amount of oxygen to be supplied to the converter 11 and the amount of cooling material to be charged into the converter 11 calculated by the first computer 3. The control device 7 includes a gas flow rate control device 7a that controls the flow rate of gas such as oxygen to be supplied to the converter 11, a sublance control device 7b that controls the operation of measuring the temperature and component concentration of the molten metal using the sublance, and an auxiliary raw material charging control device 7c that controls the operation of charging an auxiliary raw material into the converter 11. The converter blowing control system 1 also includes a second computer 6 that calculates a pre-blowing molten iron temperature that is a temperature of molten iron 12 used as a raw material for blowing in the converter 11 is charged into the converter 11 from a charging pot 13 and is in a state immediately before the start of blowing. The first computer 3 and the second computer 6 may be the same computer or different computers.

The converter blowing control system 1 also includes a third computer 8 that calculates the temperature of the molten iron 12 as the molten iron temperature during charging by using two-color temperature information of the molten iron 12 during a period when the molten iron 12 used as a raw material for blowing in the converter 11 is charged into the converter 11 from the charging pot 13, which is measured by a spectroscopic camera 2, a fourth computer 9 that calculates the pre-charging molten iron temperature change amount, which is a change amount of the temperature of the molten iron during a period from when the pre-charging molten iron temperature is measured to when the molten iron 12 is charged into the converter 11, the pre-charging molten iron temperature being a temperature of the molten iron 12 during a period when the molten iron 12 used as a raw material for blowing to be a target of the heat balance calculation is held in the charging pot 13 before being charged into the converter 11, and a fifth computer 10 that calculates the post-charging molten iron temperature change amount, which is a change amount of the temperature of the molten iron during a period from when the molten iron temperature during charging is measured to when blowing starts, the molten iron temperature during charging being a temperature of the molten iron 12 during a period when the molten iron 12 used as a raw material for blowing to be a target of the heat balance calculation is charged into the converter 11. It is only required that the converter blowing control system 1 includes at least one of the third computer 8, the fourth computer 9, and the fifth computer 10.

Then, the second computer 6 calculates the pre-blowing molten iron temperature using at least one of the molten iron temperature during charging calculated by the third computer 8, the pre-charging molten iron temperature change amount calculated by the fourth computer 9, and the post-charging molten iron temperature change amount calculated by the fifth computer 10, and the first computer 3 calculates, using the flow rate of exhaust gas measured by an exhaust gas flowmeter 4 and the composition of the exhaust gas analyzed by an exhaust gas analyzer 5 as well as the pre-blowing molten iron temperature calculated by the second computer 6 as the charged molten iron temperature, the amount of oxygen to be supplied to the converter 11 and the amount of a cooling material to be charged into the converter 11 that controls the temperature and component concentration of the molten steel at the end of blowing in the converter 11 to target values by the heat balance calculation and the material balance calculation. The first computer 3 may sequentially calculate the temperature of the molten metal during blowing using the flow rate of exhaust gas measured by the exhaust gas flowmeter 4 and the composition of exhaust gas analyzed by the exhaust gas analyzer 5 and the pre-blowing molten iron temperature calculated by the second computer 6 as the charged molten iron temperature, and the control device 7 may control blowing in the converter based on the temperature of the molten metal during blowing calculated by the first computer 3.

The spectroscopic camera 2 is installed, for example, in front of the furnace on the converter charging side, at a place where an injection flow when the molten iron 12 flows into the converter 11 from the charging pot 13 can be observed. It is preferable to install the spectroscopic camera 2 at an angle at which the injection flow is looked up because the spectroscopic camera 2 is hardly affected by dust when the molten iron is charged. In the spectroscopic camera 2, two-color temperature information is collected at a preset sampling rate (for example, every second) from the start to the end of molten iron charging. The two-color temperature information collected by the spectroscopic camera 2 is transmitted to the third computer 8 installed in an operation room or the like, and the third computer 8 calculates the molten iron temperature during charging.

The fourth computer 9 accumulates data such as the temperature measurement value of the molten iron temperature in the charging pot 13, the temperature measurement value of the molten iron temperature during charging, and the empty pot time in the past blowing, and uses the sets of data to calculate the pre-charging molten iron temperature change amount. In the calculation of the pre-charging molten iron temperature change amount, a function for giving the pre-charging molten iron temperature change amount may be derived by regression calculation or the like in the fourth computer 9, or the pre-charging molten iron temperature change amount may be calculated using the function.

The fifth computer 10 accumulates data such as the measured value of the molten iron temperature during charging in the past blowing, the actual value of the molten metal temperature during blowing measured with the sublance, and the empty furnace time, and uses the sets of data to calculate the post-charging molten iron temperature change amount. In the calculation of the post-charging molten iron temperature change amount, the charged molten iron temperature is back-calculated in the heat balance calculation to match the actual value of the molten metal temperature during blowing measured with the sublance, and, each function of the back-calculation and reading and storing data necessary for the back-calculation may be included in the fifth computer 10, or data stored in the fifth computer 10 may be written to the first computer 3 and back-calculated by the first computer 3, and the obtained solution may be read to the fifth computer 10. In addition, a function for giving the post-charging molten iron temperature change amount may be derived by regression calculation or the like in the fifth computer 10, or the post-charging molten iron temperature change amount may be calculated using the function.

The third computer 8, the fourth computer 9, and the fifth computer 10 may be the same computer or different computers. At least one of the third computer 8, the fourth computer 9, and the fifth computer 10 may be the same computer as either the first computer 3 or the second computer 6. Further, all of the first computer 3, the second computer 6, the third computer 8, the fourth computer 9, and the fifth computer 10 may be one computer.

### EXAMPLES

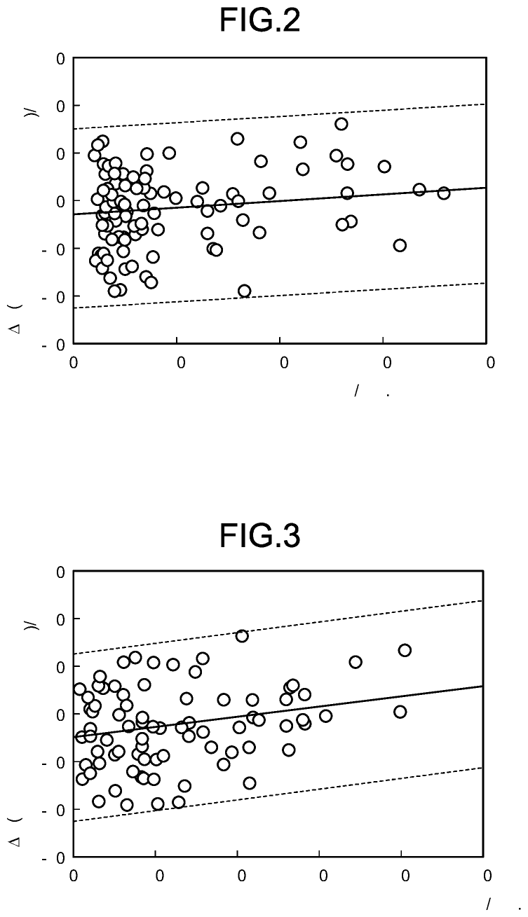

FIG. 2 is a diagram illustrating a relationship between an empty furnace time of the converter before blowing and a temperature difference obtained by subtracting an actual temperature of molten metal obtained from sublance measurement charged during blowing and an estimated temperature of the molten metal for a calculation in which the molten iron temperature during charging measured at the time of charging is equal to the pre-blowing molten iron temperature in the heat balance calculation for sequentially estimating a molten metal temperature from the operation conditions and the exhaust gas information in blowing 300 to 350 tons of molten iron using a 350-ton converter. As illustrated in FIG. 2, since the temperature difference ΔT (estimated temperature−actual temperature) in the heat balance calculation increases with increase in the empty furnace time, we confirmed that the amount of temperature drop of the molten iron in a period from when the molten iron is charged to when blowing starts also increases.

FIG. 3 is a diagram illustrating a relationship between a time from the end of molten iron charging to the start of blowing and a temperature difference obtained by subtracting an actual temperature of a molten metal obtained from sublance measurement charged during blowing from an estimated temperature of the molten metal for calculating that a molten iron temperature during charging measured at the time of charging is equal to pre-blowing molten iron temperature in heat balance calculation for sequentially estimating a molten metal temperature from the operation conditions and the exhaust gas information in blowing 300 to 350 tons of molten iron using a 350-ton converter. As with FIG. 2, we confirmed that the amount of temperature drop of the molten iron increases with increase in time from the end of molten iron charging to the start of blowing.

It can be seen from FIGS. 2 and 3 that by measuring the molten iron temperature at the time of charging to reflect the resultant in the heat balance calculation, the amount of temperature drop of the molten iron in the period from the end of molten iron charging to the start of blowing can be estimated according to the empty furnace time and the time from when the molten iron is charged to when blowing starts. Therefore, the estimation accuracy of the pre-blowing molten iron temperature can be increased by incorporating the estimated amount of temperature drop of the molten iron into the heat balance calculation.

TABLE 1

| | | Temperature drop | Temperature |
|---|---|---|---|
| | Charging | from end of charging | estimation |
| | temperature | to start of blowing | accuracy (1σ) |
| First example | Measured | Estimated | 12.9 |
| Second example | Estimated | Estimated | 13.0 |
| First compar- | Not | Not | 14.4 |
| ative example | considered | considered | |
| Second compar- | Measured | Not | 13.4 |
| ative example | | considered | |
| Third compar- | Estimated | Not | 13.4 |
| ative example | | considered | |

The results of implementation performed to confirm the effect of our method are shown in Table 1. A first example shown in Table 1 is a result (100 charges) of using the pre-blowing molten iron temperature calculated by incorporating the molten iron temperature during charging measured during charging and the post-charging molten iron temperature change amount, which is the amount of temperature drop of the molten iron after charging of the molten iron to start of blowing into the heat balance calculation for sequentially estimating a molten metal temperature from the operation conditions and the exhaust gas information when 300 to 350 tons of molten iron is blown using a 350-ton converter. The molten iron temperature during charging was 1368° C. on average for 100 charges. The post-charging molten iron temperature change amount was calculated by determining a coefficient by multiple regression from the past charge as a linear function of the empty furnace time and the time from when the molten iron is charged in the target charge to when blowing starts. Specifically, the post-charging molten iron temperature change amount (° C.)=−0.43×(time (min) from when the molten iron temperature during charging is measured to when blowing starts) −0.27×(empty furnace time (min)), and the average of 100 charges for the obtained post-charging molten iron temperature change amount was −6° C. As a result, the pre-blowing molten iron temperature was 1362° C. on average for 100 charges, and the value was used as the charged molten iron temperature in the heat balance calculation.

In addition, a second example shown in Table 1 is the pre-blowing molten iron temperature is estimated from the pre-charging molten iron temperature, the pre-charging molten iron temperature change amount, and the post-charging molten iron temperature change amount, and the resultant is incorporated into the heat balance calculation at the time of 100-charge blowing as in the first example. The pre-charging molten iron temperature was 1374° C. on average for 100 charges. The pre-charging molten iron temperature change amount was calculated from a linear function obtained by regression calculation with the empty pot time or the like as a variable. Specifically, the formula of the pre-charging molten iron temperature change amount (° C.)=−0.15×(empty pot time (min))−0.37×(empty furnace time (min)) is used, and the pre-charging molten iron temperature change amount was −8° C. on average for 100 charges. As the post-charging molten iron temperature change amount, the same value (−6° C.) as in that of the first example was used. As a result, the pre-blowing molten iron temperature was 1360° C. on average for 100 charges, and the value was used as the charged molten iron temperature in the heat balance calculation.

On the other hand, in first to third comparative examples, the molten iron temperature during charging and the post-charging molten iron temperature change amount, which is an amount of temperature drop of the molten iron after charging of the molten iron to start of blowing into the heat balance calculation, were not incorporated into the heat balance calculation in 100 charges different from the invention example. In the first comparative example, the pre-charging molten iron temperature (1374° C. on average for 100 charges) was directly used as the pre-blowing molten iron temperature for the heat balance calculation. In the second comparative example, the measured value (1362° C. on average for 100 charges) of the molten iron temperature during charging was directly used as the pre-blowing molten iron temperature for the heat balance calculation. In the third comparative example, the sum (1360° C. on average for 100 charges) of the pre-charging molten iron temperature (1374° C. on average for 100 charges) and the pre-charging molten iron temperature change amount (−14° C. on average for 100 charges) was used as the pre-blowing molten iron temperature for the heat balance calculation.

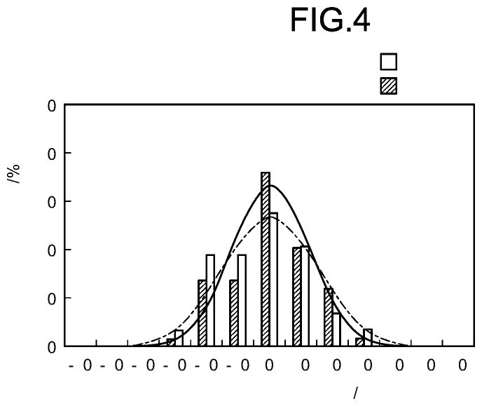

The temperature estimation accuracy in Table 1 is a value of the standard deviation of an error between the estimated temperature obtained by sequentially estimating the molten metal temperature from the exhaust gas information up to the intermediate sublance charged time point using the blowing start temperature measured or estimated under each condition and the actual temperature obtained by the intermediate sublance. As is clear from Table 1 and FIG. 4 illustrating the first example and the first comparative example in Table 1, it can be seen that the accuracy in our example is increased compared to the comparative example. Our method is not limited to the heat balance calculation in which the molten metal temperature is sequentially estimated from the operation conditions and the exhaust gas information, and is also applicable to the static control.

Although the examples have been described above, this disclosure is not limited by the description and drawings constituting a part of this disclosure according to the examples. That is, other configurations, examples, operation techniques and the like made by those skilled in the art based on the examples are all included in the scope of this disclosure.

### INDUSTRIAL APPLICABILITY

It is thus possible to provide the converter blowing control method and the converter blowing control system capable of accurately controlling the temperature of molten steel at the end of blowing to a target value.

1.-15. (canceled)

16. A converter blowing control method comprising:
calculating, by heat balance calculation and material balance calculation, an amount of oxygen to be supplied and an amount of a cooling material or a rising heat material to be charged to control a temperature and a component concentration of molten steel at end of blowing in a converter to target values; and
controlling the blowing in the converter based on the calculated amount of oxygen to be supplied and the calculated amount of a cooling material or a rising heat material to be charged, wherein
the method comprises:
estimating a pre-blowing molten iron temperature that is a temperature of molten iron used as a raw material for blowing to be a target of the heat balance calculation, charged into the converter, and is in a state immediately before start of the blowing, and
using the estimated pre-blowing molten iron temperature as a charged molten iron temperature in the heat balance calculation.

17. A converter blowing control method comprising:
sequentially estimating a temperature and a component concentration of molten metal at progress of blowing by sequentially performing heat balance calculation and material balance calculation during the blowing based on operation conditions and a measured value of a converter obtained at start of and during the blowing in the converter; and
controlling the blowing in the converter based on the estimated temperature and the estimated component concentration of the molten metal, wherein
the method comprises:
estimating a pre-blowing molten iron temperature that is a temperature of molten iron used as a raw material for blowing to be a target of the heat balance calculation, charged into the converter, and is in a state immediately before start of the blowing, and
using the estimated pre-blowing molten iron temperature as a charged molten iron temperature in the heat balance calculation.

18. The converter blowing control method according to claim 16, wherein a value obtained by adding a post-charging molten iron temperature change amount to a molten iron temperature during charging is used as the charged molten iron temperature used in the heat balance calculation, the post-charging molten iron temperature change amount being a molten iron temperature change amount in a period from when the molten iron is charged into the converter to when the blowing starts, and the molten iron temperature during charging being a temperature of the molten iron measured during a period when the molten iron used as the raw material for the blowing to be a target of the heat balance calculation is charged into the converter.

19. The converter blowing control method according to claim 16, wherein a value obtained by adding a pre-charging molten iron temperature change amount and a post-charging molten iron temperature change amount to a pre-charging molten iron temperature is used as the charged molten iron temperature used in the heat balance calculation, the pre-charging molten iron temperature being a temperature of the molten iron measured during a period when the molten iron used as the raw material for the blowing to be a target of the heat balance calculation is held in a molten iron holding container before being charged into the converter, the pre-charging molten iron temperature change amount being a molten iron temperature change amount during a period from measurement of the pre-charging molten iron temperature to charging of the molten iron into the converter, and the post-charging molten iron temperature change amount being a molten iron temperature change amount during a period from when the molten iron is charged into the converter to when the blowing starts.

20. The converter blowing control method according to claim 19, wherein the post-charging molten iron temperature change amount is determined based on a difference between a back-calculated value of the charged molten iron temperature back-calculated from the heat balance calculation to match a measured value of a molten metal temperature during blowing performed in past blowing and the molten iron temperature during charging in the past blowing.

21. The converter blowing control method according to claim 20, wherein the post-charging molten iron temperature change amount is determined for further consideration of at least one of a time from when a previous charge of a target charge is discharged to when the molten iron of the target charge is charged and a time from when the molten iron of the target charge is charged to when the blowing starts.

22. The converter blowing control method according to claim 19, wherein the pre-charging molten iron temperature change amount is determined based on a difference between the pre-charging molten iron temperature in the past blowing and the molten iron temperature during charging in the past blowing.

23. The converter blowing control method according to claim 22, wherein the pre-charging molten iron temperature change amount is determined for further consideration of at least one of an elapsed time from a time at which the molten iron in the previous charge of the target charge is discharged to a receiving time at which the molten iron to be used for blowing of the target charge is received in a molten iron holding container to receive the molten iron to be used for blowing of the target charge and a time from when the pre-charging molten iron temperature is measured to when the molten iron is charged into the converter.

24. A converter blowing control system comprising:
a first computer configured to calculate, by heat balance calculation and material balance calculation, an amount of oxygen to be supplied to a converter and an amount of a cooling material or a rising heat material to be charged into the converter to control a temperature and a component concentration of molten steel at end of blowing in the converter to target values;
a control device configured to control the blowing in the converter based on the amount of oxygen to be supplied to the converter and the amount of a cooling material or a rising heat material to be charged into the converter calculated by the first computer;
a second computer configured to calculate a pre-blowing molten iron temperature that is a temperature of molten iron used as a raw material for the blowing in the converter, is charged into the converter, and is in a state immediately before start of the blowing; and
at least one of
a third computer configured to calculate, as a molten iron temperature during charging, a temperature of the molten iron used as the raw material for the blowing to be a target of the heat balance calculation by using two-color temperature information of the molten iron during a period when the molten iron is charged into the converter,
a fourth computer configured to calculate a pre-charging molten iron temperature change amount that is a molten iron temperature change amount during a period from when a pre-charging molten iron temperature is measured to when the molten iron is charged into the converter, the pre-charging molten iron temperature being a temperature of the molten iron during a period when the molten iron used as the raw material for the blowing to be a target of the heat balance calculation is held in a molten iron holding container before being charged into the converter, and
a fifth computer configured to calculate a post-charging molten iron temperature change amount that is a molten iron temperature change amount in a period from when the molten iron used as the raw material for the blowing to be a target of the heat balance calculation is charged into the converter to when the blowing starts, wherein
the second computer is configured to calculate the pre-blowing molten iron temperature using at least one of the molten iron temperature during charging calculated by the third computer, the pre-charging molten iron temperature change amount calculated by the fourth computer, and the post-charging molten iron temperature change amount calculated by the fifth computer, and
the first computer is configured to calculate, using the pre-blowing molten iron temperature calculated by the second computer as a charged molten iron temperature, the amount of oxygen to be supplied to the converter and the amount of a cooling material or a rising heat material to be charged into the converter for controlling the temperature and the component concentration of the molten steel at the end of the blowing in the converter to the target values by the heat balance calculation and the material balance calculation.

25. A converter blowing control system comprising:
a first computer configured to sequentially calculate a temperature and a component concentration of molten metal during blowing by performing heat balance calculation and material balance calculation based on operation conditions and a measured value of a converter obtained at start of and during the blowing in the converter;
a control device configured to control the blowing in the converter based on the temperature and the component concentration of the molten metal during the blowing calculated by the first computer;
a second computer configured to calculate a pre-blowing molten iron temperature that is a temperature of molten iron used as a raw material for the blowing in the converter, is charged into the converter, and is in a state immediately before start of the blowing; and
at least one of
a third computer configured to calculate, as a molten iron temperature during charging, the temperature of the molten iron used as the raw material for the blowing in the converter by using two-color temperature information of the molten iron during a period when the molten iron is charged into the converter,
a fourth computer configured to calculate a pre-charging molten iron temperature change amount that is a molten iron temperature change amount during a period from when a pre-charging molten iron temperature is measured to when the molten iron is charged into the converter, the pre-charging molten iron temperature being a temperature of the molten iron used as the raw material for the blowing in the converter during a period when the molten iron is held in a molten iron holding container before being charged into the converter, and
a fifth computer configured to calculate a post-charging molten iron temperature change amount that is a molten iron temperature change amount in a period from when the molten iron used as the raw material for the blowing in the converter is charged into the converter to when the blowing starts, wherein
the second computer is configured to calculate the pre-blowing molten iron temperature using at least one of the molten iron temperature during charging calculated by the third computer, the pre-charging molten iron temperature change amount calculated by the fourth computer, and the post-charging molten iron temperature change amount calculated by the fifth computer, and
the first computer is configured to sequentially calculate the temperature of the molten metal during blowing using, as a charged molten iron temperature, the pre-blowing molten iron temperature calculated by the second computer.

26. The converter blowing control method according to claim 17, wherein a value obtained by adding a post-charging molten iron temperature change amount to a molten iron temperature during charging is used as the charged molten iron temperature used in the heat balance calculation, the post-charging molten iron temperature change amount being a molten iron temperature change amount in a period from when the molten iron is charged into the converter to when the blowing starts, and the molten iron temperature during charging being a temperature of the molten iron measured during a period when the molten iron used as the raw material for the blowing to be a target of the heat balance calculation is charged into the converter.

27. The converter blowing control method according to claim 17, wherein a value obtained by adding a pre-charging molten iron temperature change amount and a post-charging molten iron temperature change amount to a pre-charging molten iron temperature is used as the charged molten iron temperature used in the heat balance calculation, the pre-charging molten iron temperature being a temperature of the molten iron measured during a period when the molten iron used as the raw material for the blowing to be a target of the heat balance calculation is held in a molten iron holding container before being charged into the converter, the pre-charging molten iron temperature change amount being a molten iron temperature change amount during a period from measurement of the pre-charging molten iron temperature to charging of the molten iron into the converter, and the post-charging molten iron temperature change amount being a molten iron temperature change amount during a period from when the molten iron is charged into the converter to when the blowing starts.

28. The converter blowing control method according to claim 27, wherein the post-charging molten iron temperature change amount is determined based on a difference between a back-calculated value of the charged molten iron temperature back-calculated from the heat balance calculation to match a measured value of a molten metal temperature during blowing performed in past blowing and the molten iron temperature during charging in the past blowing.

29. The converter blowing control method according to claim 28, wherein the post-charging molten iron temperature change amount is determined for further consideration of at least one of a time from when a previous charge of a target charge is discharged to when the molten iron of the target charge is charged and a time from when the molten iron of the target charge is charged to when the blowing starts.

30. The converter blowing control method according to claim 27, wherein the pre-charging molten iron temperature change amount is determined based on a difference between the pre-charging molten iron temperature in the past blowing and the molten iron temperature during charging in the past blowing.

31. The converter blowing control method according to claim 30, wherein the pre-charging molten iron temperature change amount is determined for further consideration of at least one of an elapsed time from a time at which the molten iron in the previous charge of the target charge is discharged to a receiving time at which the molten iron to be used for blowing of the target charge is received in a molten iron holding container for receiving the molten iron to be used for blowing of the target charge and a time from when the pre-charging molten iron temperature is measured to when the molten iron is charged into the converter.
